(19) United States
(12) Patent Application Publication
(10) Pub. No.: US 2018/0191140 A1
(43) Pub. Date: Jul. 5, 2018

(54) CONDUIT ATTACHMENT SYSTEM FOR A CABLE PULLER

(71) Applicant: Greenlee Textron Inc., Rockford, IL (US)

(72) Inventors: James Donald Schmidt, Rockford, IL (US); Matt Stephen Hayes, Rockford, IL (US); Avery Paul Rosenbloom, Loves Park, IL (US)

(21) Appl. No.: 15/405,969

(22) Filed: Jan. 13, 2017

Related U.S. Application Data
(60) Provisional application No. 62/440,665, filed on Dec. 30, 2016.
(60) Provisional application No. 62/443,048, filed on Jan. 6, 2017.

(51) Int. Cl. H02G 1/08

(52) U.S. Cl. CPC H02G 1/085

(57) ABSTRACT

A conduit attachment system according to some embodiments of the disclosure is configured to be attached to a cable puller for securing the cable puller to a threaded conduit. The attachment system includes a mounting member configured to be attached to the cable puller, an engaging member attached to the mounting member, and a clamp plate attached to the mounting member, the clamp plate configured to be inserted into a passageway of the conduit and configured to bear against an inner surface of the conduit which forms the passageway. One of the engaging member and the clamp plate has a ledge surface upon which the end surface of the conduit bears against. At least one of the engaging member and the clamp plate is adjustable in position relative to the mounting member.

This application claims priority to U.S. provisional application Ser. No. 62/440,665, filed on Dec. 30, 2016, U.S. provisional application Ser. No. 62/443,048, filed on Jan. 6, 2017; the contents of which are incorporated herein in its entirety.

### FIELD OF THE DISCLOSURE

The present disclosure relates to the field of pulling, and relates specifically to an attachment system configured to mount a cable puller to a conduit.

### BACKGROUND

Cable pullers are often used to pull cables or wires, for example, telephone wires, optical cables, or electrical service cables, through conduit. A typical cable puller generally includes a base and a boom extending from the base. An elbow is provided at the free end of the boom and an attachment system is mounted to the elbow for attachment to the conduit. The cables or wires are pulled through the conduit using the cable puller.

### SUMMARY

A conduit attachment system according to some embodiments of the disclosure is configured to be attached to a cable puller for securing the cable puller to a threaded conduit. The attachment system includes a mounting member configured to be attached to the cable puller, an engaging member attached to the mounting member, and a clamp plate attached to the mounting member, the clamp plate configured to be inserted into a passageway of the conduit and configured to bear against an inner surface of the conduit which forms the passageway. One of the engaging member and the clamp plate has a ledge surface upon which an end surface of the conduit bears against. At least one of the engaging member and the clamp plate is adjustable in position relative to the mounting member.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 is a perspective view of a cable puller showing a first embodiment of an attachment system attached thereto and in accordance with the present disclosure;

FIG. 2 is a perspective view of a prior art conduit which is configured to be attached to the attachment system;

FIG. 3 is a perspective view of the attachment system; the attachment system being formed of a mounting member and a clamping and engaging assembly;

FIG. 4 is a perspective view of a portion of the mounting member and of the clamping and engaging assembly;

FIG. 5 is a perspective view of a mount plate of the mounting member;

FIG. 6 is a front elevation view the mount plate;

FIG. 7 is a perspective view of a clamp plate of the clamping and engaging assembly of FIG. 3;

FIG. 8 is a front elevation view of the clamp plate;

FIG. 9 is a rear elevation view of the clamp plate;

FIG. 10 is a side elevation view of a knob of the clamping and engaging assembly;

FIG. 11 is a cross-sectional view of the attachment system and conduit;

FIG. 12 is a perspective view of an engaging member of the clamping and engaging assembly;

FIG. 13 is a side elevation view of the engaging member;

FIG. 14 is a front elevation view of the engaging member;

FIG. 15 is a bottom plan view of the engaging member;

FIG. 16 is a bottom plan view of the engaging member and the conduit;

FIG. 17 is a partial perspective view of a second embodiment of an attachment system in accordance with the present disclosure;

FIG. 18 is a perspective view of a third embodiment of an attachment system in accordance with the present disclosure and shown attached to a conduit;

FIG. 19 is a perspective view of the attachment system of FIG. 18, the attachment system being formed of a mounting member and a clamping and engaging assembly;

FIG. 20 is a perspective view of a portion of the mounting member and of the clamping and engaging assembly of FIG. 19;

FIG. 21 is an exploded perspective view of the portion of the mounting member and the clamping and engaging assembly of FIG. 20;

FIG. 22 is a perspective view of a mount plate of the mounting member of FIG. 19, with a clamp plate of the clamping and engaging assembly of FIG. 19 attached thereto;

FIG. 23 is a front elevation view the mount plate of the mounting member of FIG. 19, and the clamp plate of the clamping and engaging assembly of FIG. 19 attached thereto;

FIG. 24 is a side elevation view of an engaging member and an adjustment knob of the clamping and engaging assembly of FIG. 19;

FIG. 25 is a perspective view of the engaging member of the clamping and engaging assembly of FIG. 19;

FIG. 26 is a side elevation view of the engaging member of the clamping and engaging assembly of FIG. 19;

FIG. 27 is a front elevation view of the engaging member of the clamping and engaging assembly of FIG. 19;

FIG. 28 is a top plan view of the engaging member of the clamping and engaging assembly of FIG. 19;

FIG. 29 is a perspective view of a fourth embodiment of an attachment system in accordance with the present disclosure and shown attached to a conduit;

FIG. 30 is a perspective view of the attachment system of FIG. 29, the attachment system being formed of a mounting member and a clamping and engaging assembly;

FIG. 31 is a perspective view of a portion of the mounting member and of the clamping and engaging assembly of FIG. 29;

FIG. 32 is an exploded perspective view of the portion of the mounting member and the clamping and engaging assembly of FIG. 30;

FIG. 33 is a perspective view of a mount plate of the mounting member of FIG. 29;

FIG. 34 is a front elevation view the mount plate of the mounting member of FIG. 29;

FIG. 35 is a first side elevation view of a clamp plate of the clamping and engaging assembly of FIG. 29;

FIG. 36 is a second side elevation view of a clamp plate of the clamping and engaging assembly of FIG. 29;

FIG. 37 is a perspective view of an engaging member of the clamping and engaging assembly of FIG. 29;

FIG. 38 is a side elevation view of the engaging member of the clamping and engaging assembly of FIG. 29;

FIG. 39 is a front elevation view of the engaging member of the clamping and engaging assembly of FIG. 29;

FIG. 40 is a top plan view of the engaging member of the clamping and engaging assembly of FIG. 29;

FIG. 41 is a perspective view of a fifth embodiment of an attachment system in accordance with the present disclosure and shown attached to a conduit;

FIG. 42 is a perspective view of the attachment system of FIG. 41, the attachment system being formed of a mounting member and a clamping and engaging assembly;

FIG. 43 is a perspective view of a portion of the mounting member and of the clamping and engaging assembly of FIG. 41;

FIG. 44 is an exploded perspective view of the portion of the mounting member and the clamping and engaging assembly of FIG. 30;

FIG. 45 is a first side elevation view of a clamp plate of the clamping and engaging assembly of FIG. 41;

FIG. 46 is a second side elevation view of a clamp plate of the clamping and engaging assembly of FIG. 41;

FIG. 47 is a perspective view of an engaging member of the clamping and engaging assembly of FIG. 41;

FIG. 48 is a side elevation view of the engaging member of the clamping and engaging assembly of FIG. 41;

FIG. 49 is a front elevation view of the engaging member of the clamping and engaging assembly of FIG. 41; and

FIG. 50 is a cross-sectional view of the engaging member of the clamping and engaging assembly of any of the embodiments shown in slight engagement with the conduit.

### DETAILED DESCRIPTION

While the disclosure may be susceptible to embodiment in different forms, there is shown in the drawings, and herein will be described in detail, a specific embodiment with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

An attachment system 120, 220, 320, 420, 520 is provided for use with a cable puller 22 to pull cable through a stationary conduit 24. The attachment system 120, 220, 320, 420, 520 is quickly and rigidly mounted to a cable puller 22 and accommodates to many types and sizes of conduit 24. The attachment system 120, 220, 320, 420, 520 of various embodiments can withstand 6000 lbs. of pulling force.

The conduit 24 is mounted in a wall (not shown) to which the attachment system 120, 220, 320, 420, 520 is secured and through which a cable (not shown) is to be pulled. As shown in FIG. 2, the conduit 24 is generally cylindrically-shaped and includes an inner surface 26 defining a passageway 28, an outer surface 30, and an end surface 32. A plurality of threads 34 are provided on the outer surface 30 of the conduit 24 proximate to the end surface 32.

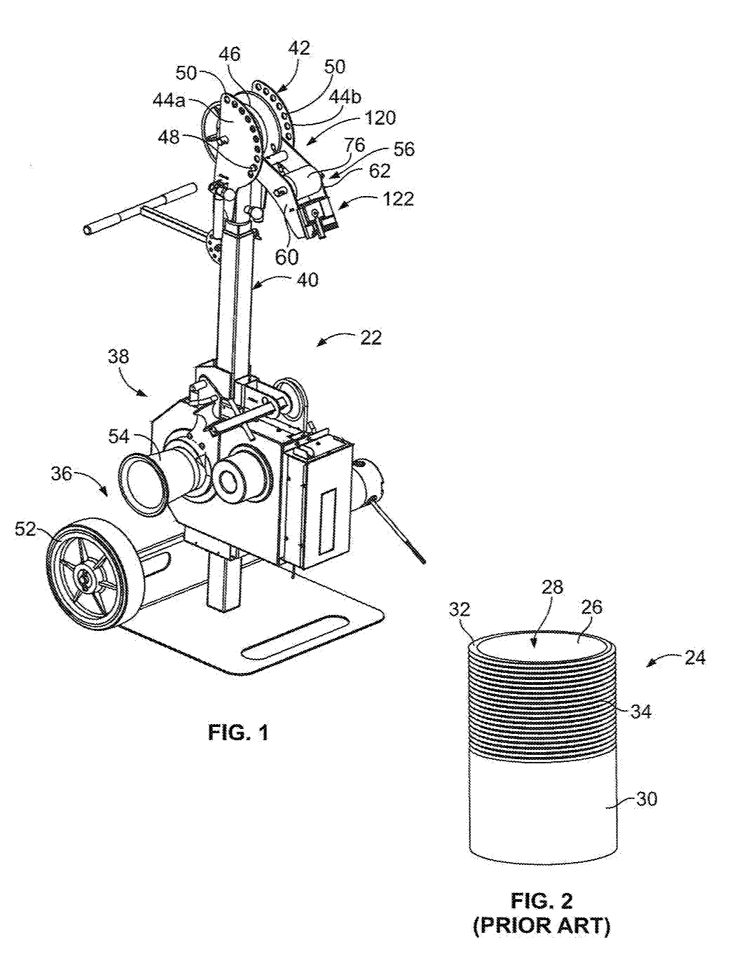

As best shown in FIG. 1, the cable puller 22 generally includes a base 36, a puller assembly 38, a boom 40 extending from the puller assembly 38, and an adjustable elbow 42 attached to the boom 40. In an embodiment, the boom 40 is telescoping. The attachment system 120, 220, 320, 420, 520 is mounted to the cable puller 22 at the elbow 42. The position of the attachment system 120, 220, 320, 420, 520 can be adjusted relative to the boom 40 by adjusting the position of the elbow 42. In an embodiment, the elbow 42 comprises a pair of plates 44a, 44b having a roller 46 rotatably mounted therebetween. The roller 46 provides an axis about which the attachment system 120, 220, 320, 420, 520 can be rotated to adjust the angle of the attachment system 120, 220, 320, 420, 520 relative to the elbow 42. The relative positions of the elbow 42 and the attachment system 120, 220, 320, 420, 520 are secured by passing a pin 48 through adjustment apertures 50 of the plates 44a, 44b of the elbow 42 and through the attachment system 120, 220, 320, 420, 520.

In an embodiment, the base 24 may rest on the floor or ground and may have wheels 52 for transportation of the cable puller 22. The puller assembly 38 includes a capstan 54 about which the cable to be pulled is wound.

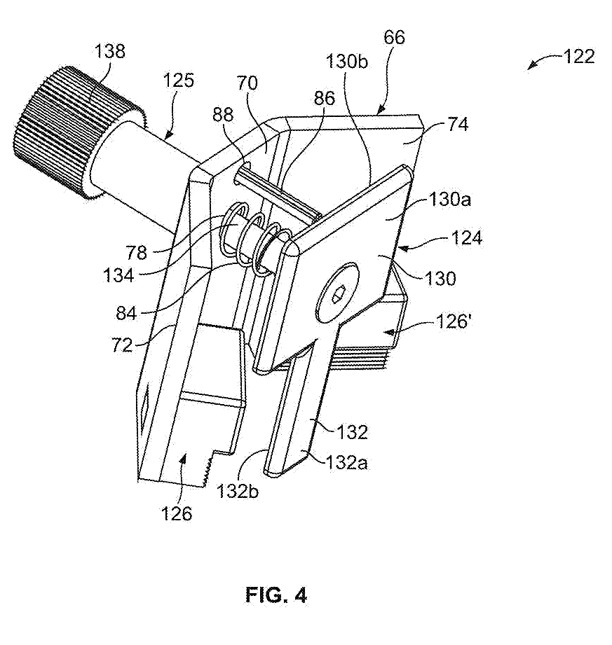

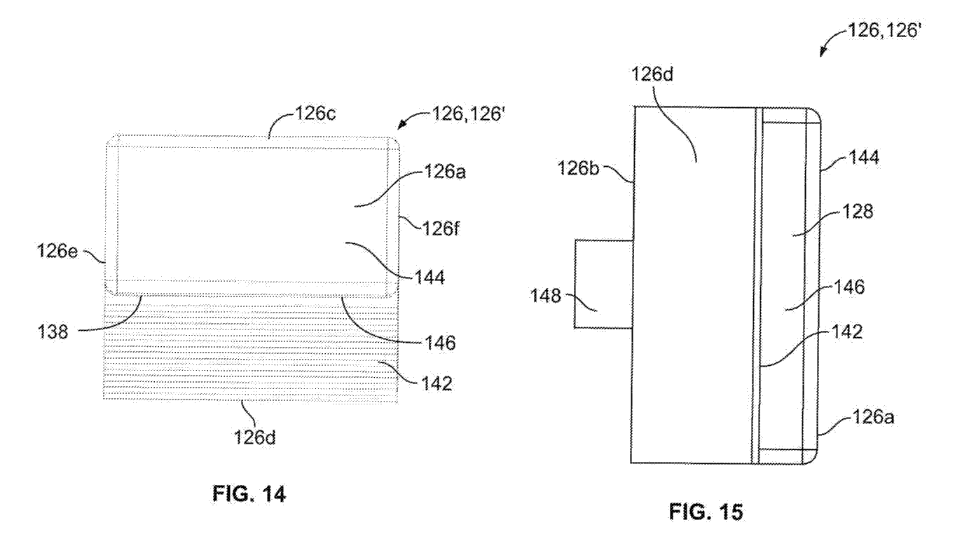

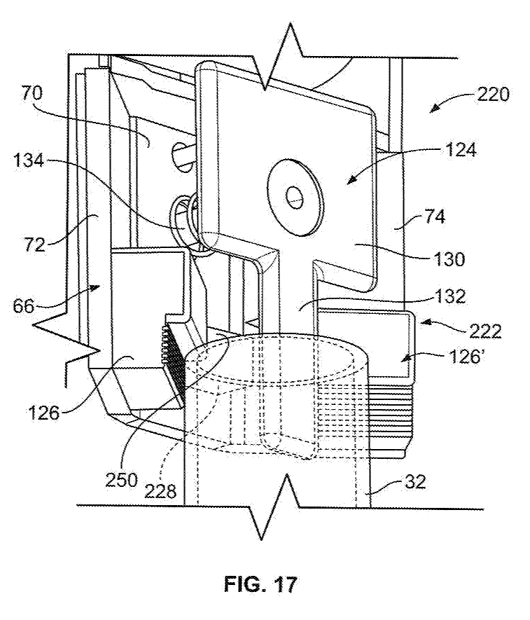

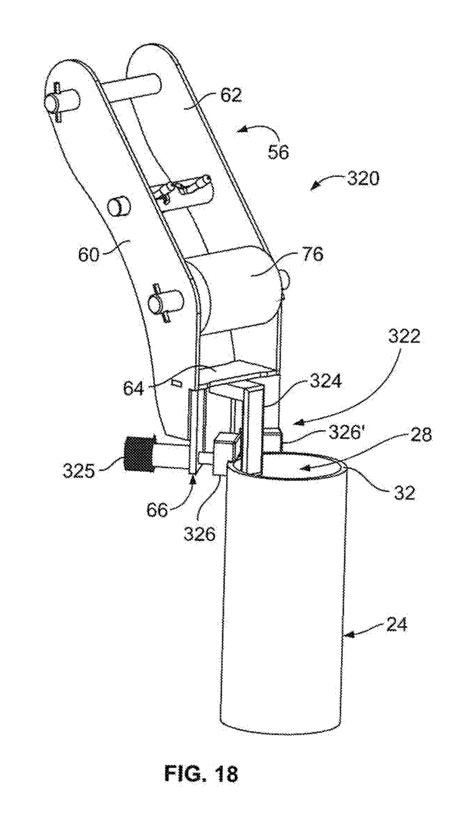

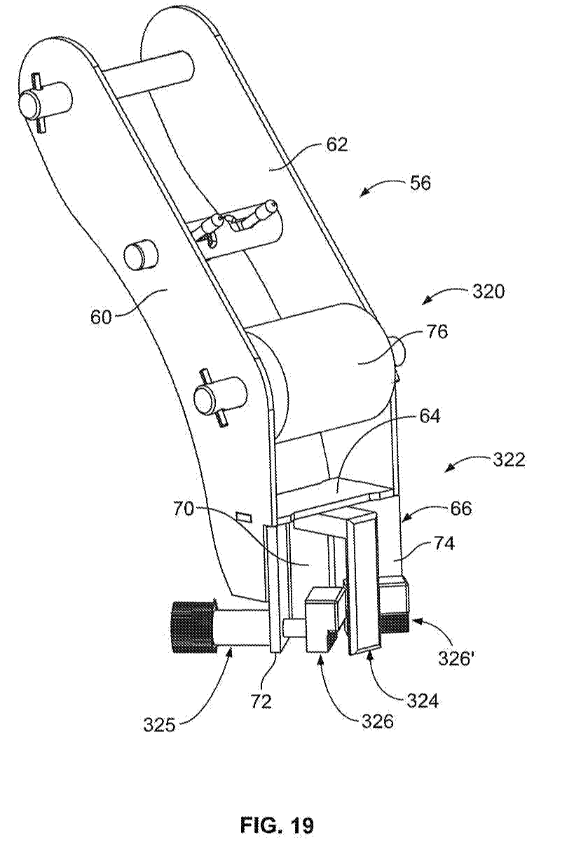

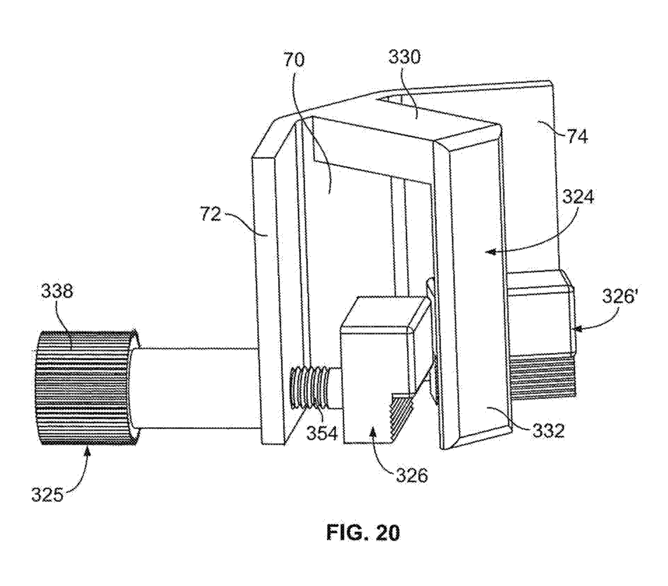

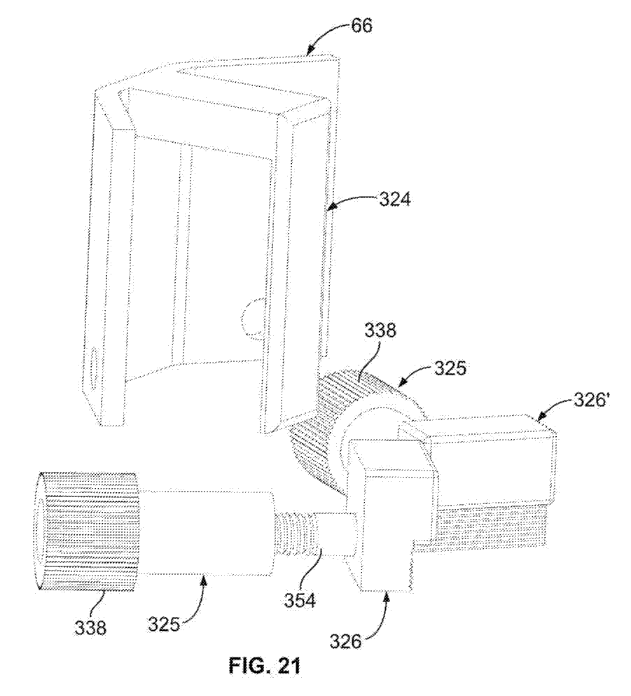

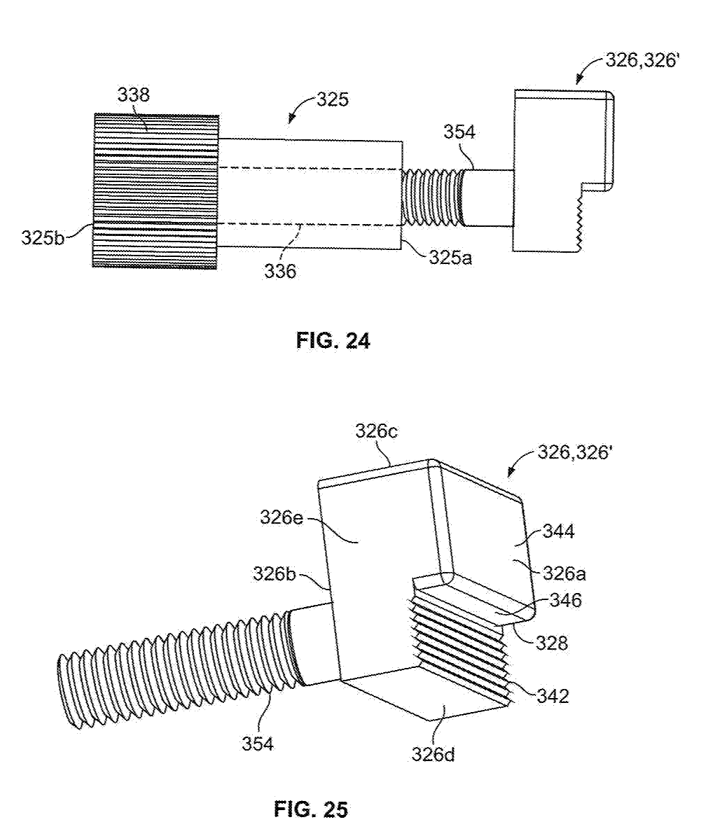

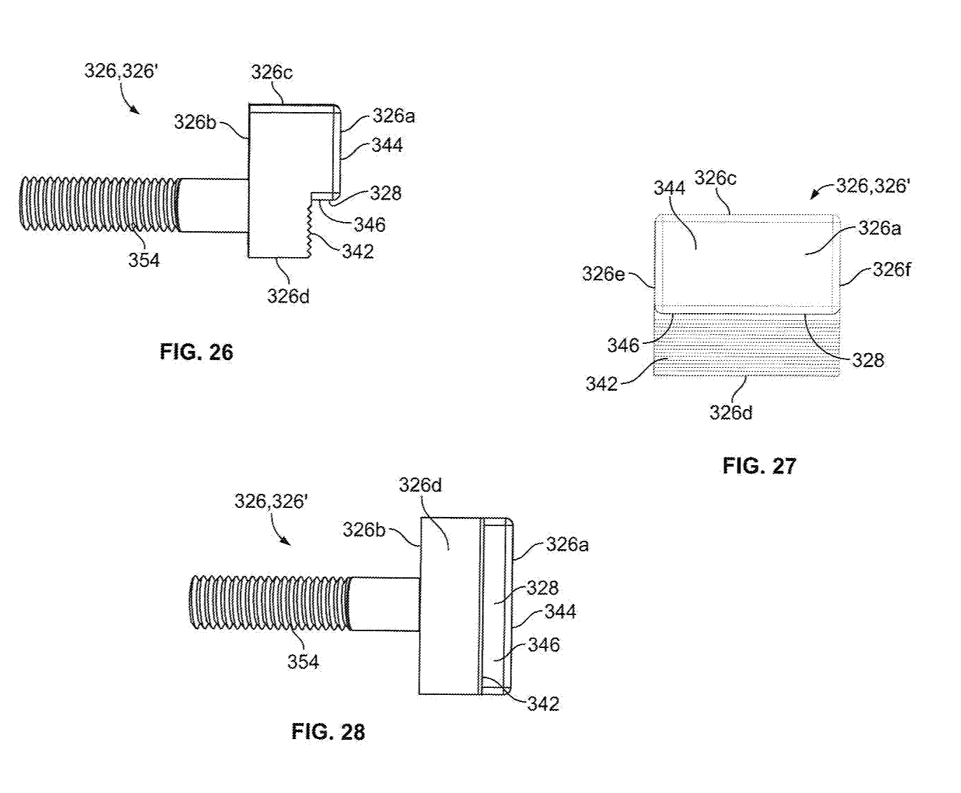

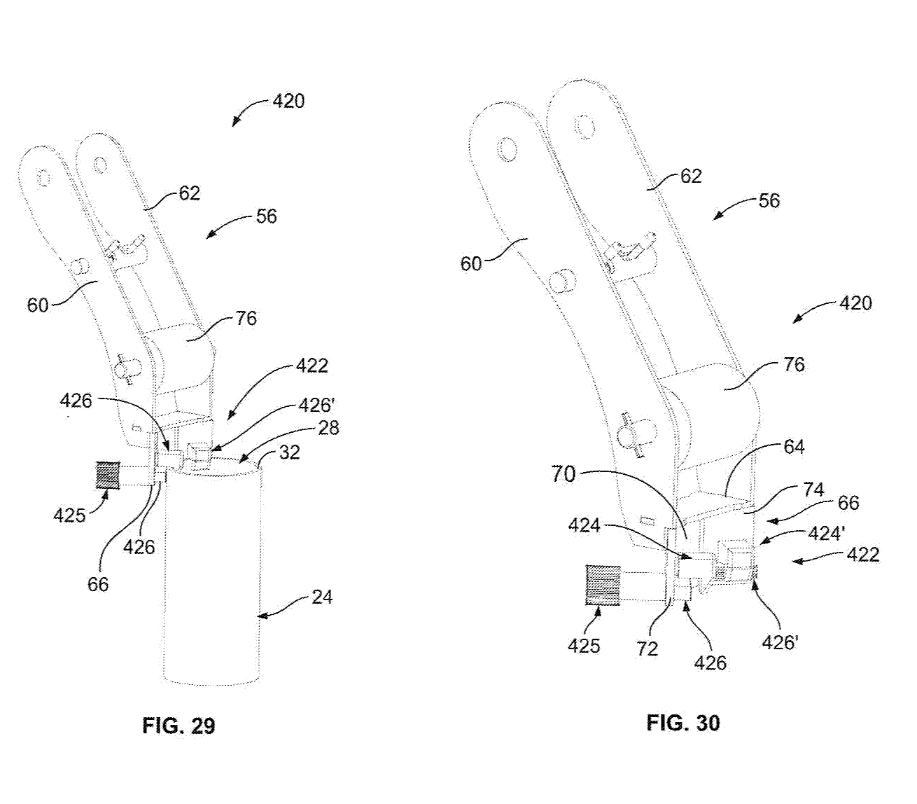

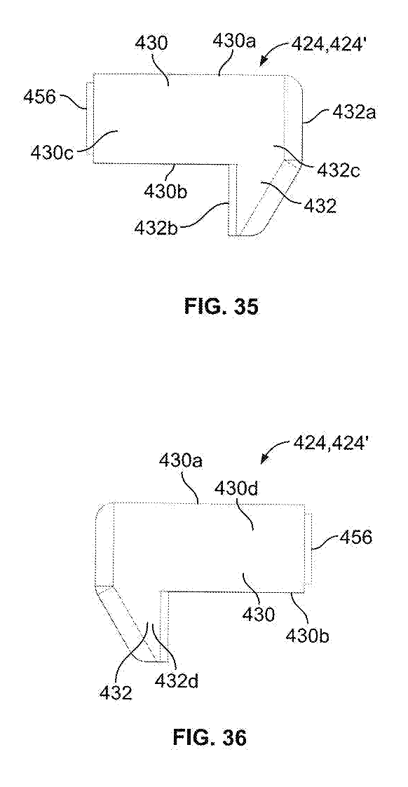

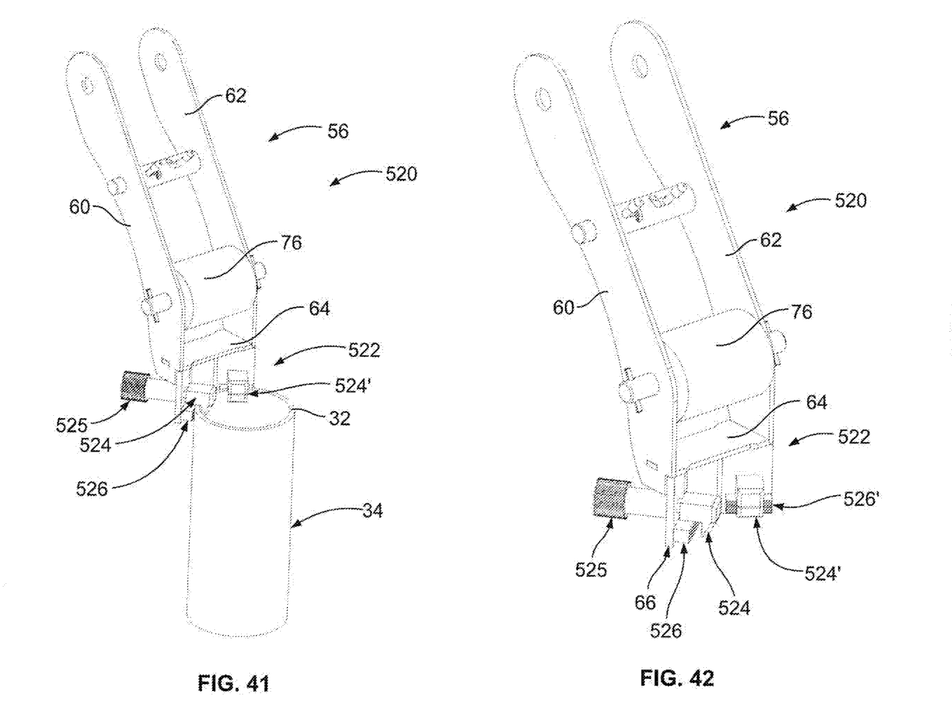

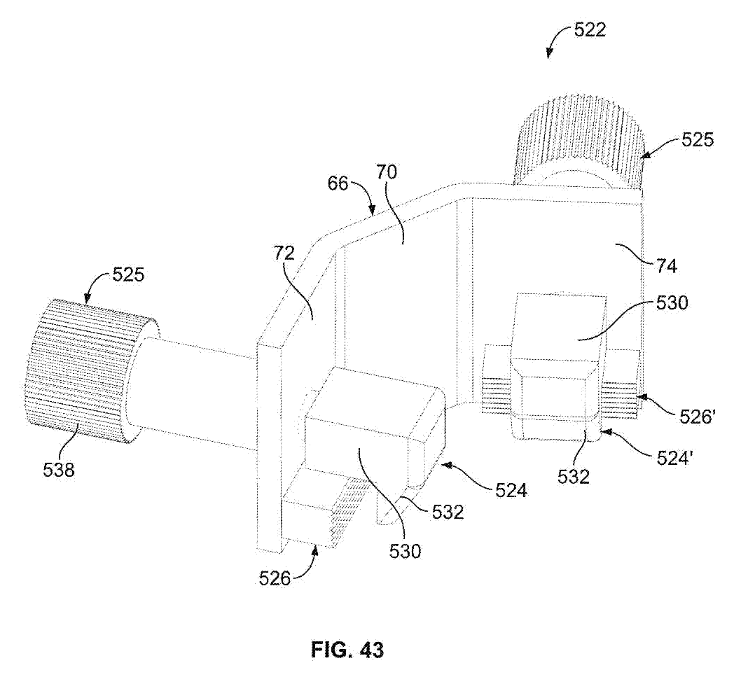

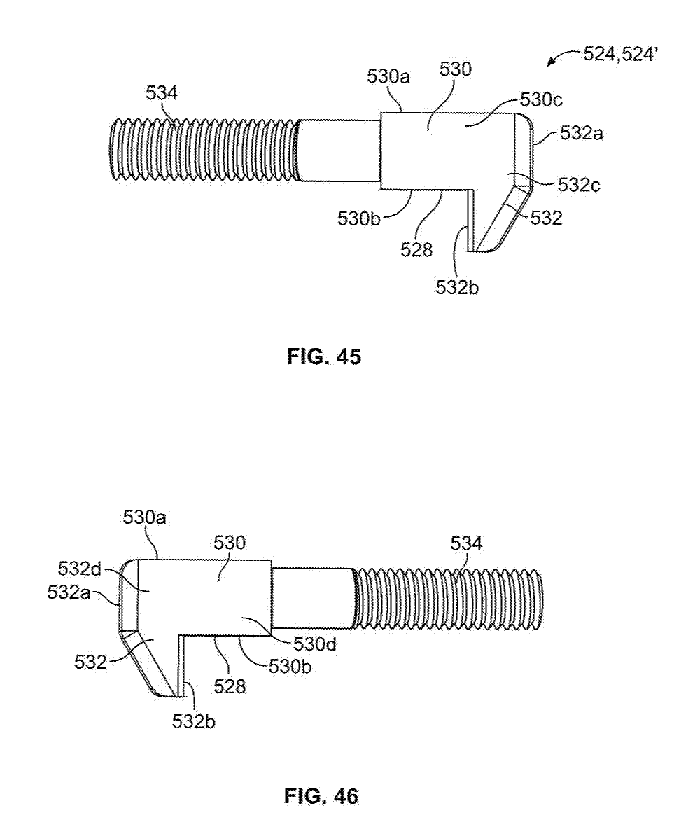

A first embodiment of the attachment system 120 is shown in FIGS. 1-16; a second embodiment of the attachment system 220 is shown in FIG. 17; a third embodiment of the attachment system 320 is shown in FIGS. 18-28; a fourth embodiment of the attachment system 420 is shown in FIGS. 29-40; and a fifth embodiment of the attachment system 520 is shown in FIGS. 41-49. Each embodiment of the attachment system 120, 220, 320, 420, 520 includes a mounting member 56 and a clamping and engaging assembly 122, 222, 322, 422, 522 attached to the mounting member 56. The mounting member 56 is attached to the elbow 42 of the cable puller 22 between the plates 44a, 44b.

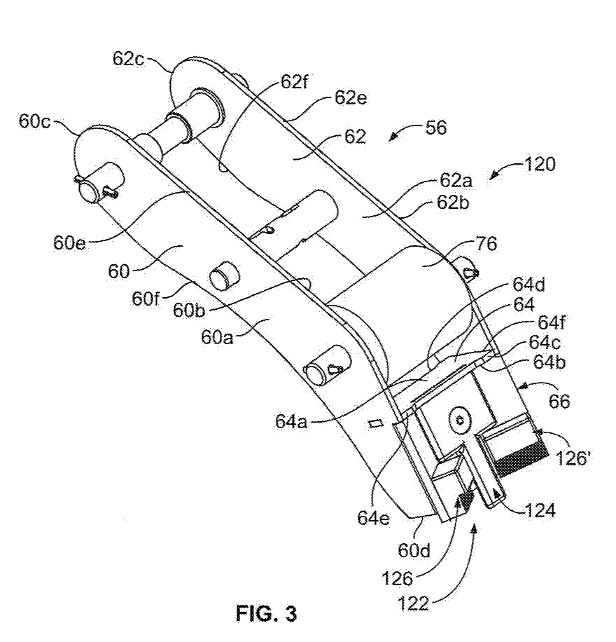

In each embodiment, as shown in FIG. 3, the mounting member 56 includes first and second support arms 60, 62, a cross-brace 64 extending between the support arms 60, 62, and a mount plate 66 extending between the support arms 60, 62. The support arms 60, 62, the cross-brace 64 and the mount plate 66 are affixed to each other to form a one-piece member.

The first support arm 60 has first and second surfaces 60a, 60b which defines a top edge 60c, a bottom edge 60d, a front edge 60e and a rear edge 60f. The second support arm 62 has first and second surfaces 62a, 62b which defines a top edge 62c, a bottom edge 62d, a front edge 62e and a rear edge 62f. The support arms 60, 62 are positioned parallel to each other, but spaced apart from each other by the cross-brace 64 and the mount plate 66. The second surface 60b of the first support arm 60 faces the first surface 62a of the second support arm 62. In an embodiment, the support arms 60, 62 are generally triangularly-shaped.

The cross-brace 64 has an upper surface 64a, and an opposite lower surface 64b which defines a front edge 64c, a rear edge 64d and opposite first and second side edges 64e, 64f. The cross-brace 64 extends between the support arms 60, 62 such that the first side edge 64e mates with the second surface 60b of the first support arm 60, and the second side edge 64f mates with the first surface 62a of the second support arm 62. In an embodiment, the cross-brace 64 is generally rectangularly-shaped.

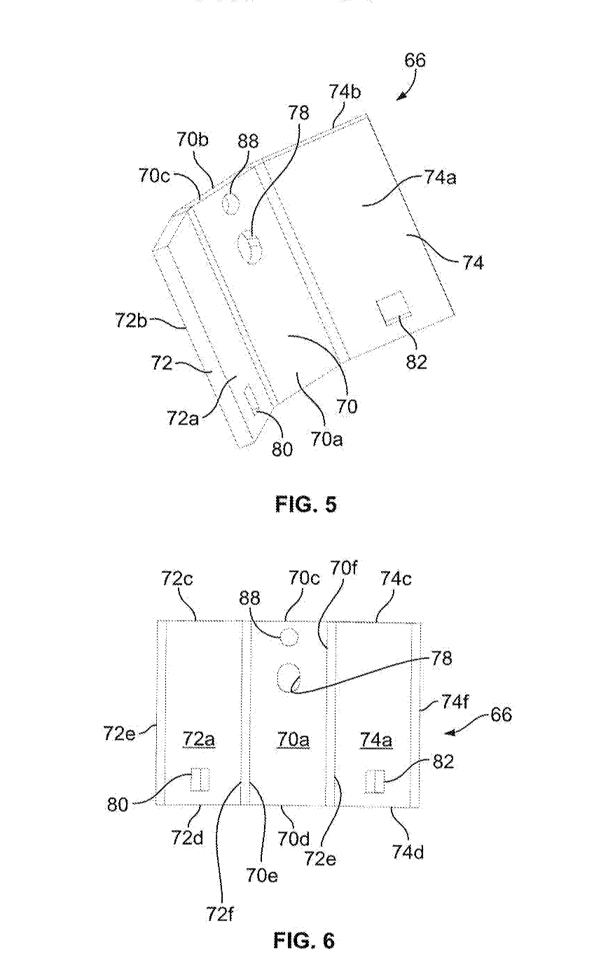

As shown in FIGS. 5 and 6, the mount plate 66 includes a base wall 70, a first support wall 72 extending from the base wall 70 and at an angle thereto, and a second support wall 74 extending from the base wall 70 and at an angle thereto. In an embodiment, the first support wall 70 is angled relative to the base wall 70 at an angle of 30 degrees to 45 degrees and the second support wall 74 is angled relative to the base wall 70 at an angle of 30 degrees to 45 degrees for a conduit 24 having a diameter of 1 to 5 inches. In an embodiment, the angle is 37.5 degrees and the conduit 24 has a diameter of 3 inches. The mount plate 66 extends downwardly from the cross-brace 64 and extends between the support arms 60, 62. In an embodiment, each of the walls 70, 72, 74 are generally rectangularly-shaped.

The base wall 70 has a front surface 70a and an opposite rear surface 70b which defines a top edge 70c, a bottom edge 70d and opposite side edges 70e, 70f The top edge 70c of the base wall 70 is attached to the lower surface 74b of the cross-brace 64 such that the base wall 70 extends downwardly from the cross-brace 64.

The first support wall 72 has a front surface 72a and an opposite rear surface 72b which defines a top edge 72c, a bottom edge 72d and opposite side edges 72e, 72f. The second side edge 72f of the first support wall 72 mates with the first side edge 70e of the base wall 72. The top edge 72c of the first support wall 72 is attached to the lower surface 74b of the cross-brace 64 such that the first support wall 72 extends downwardly from the cross-brace 64. The first side edge 72e of the first support wall 72 is attached to the outer surface 60e of the first support arm 60. The bottom edge 72d is free.

The second support wall 74 has a front surface 74a and an opposite rear surface 74b which defines a top edge 74c, a bottom edge 74d and opposite side edges 74e, 74f The first side edge 74e of the second support wall 74 mates with the second side edge 70f of the base wall 74. The top edge 74c of the second support wall 74 is attached to the lower surface 74b of the cross-brace 64 such that the second support wall 74 extends downwardly from the cross-brace 64. The second side edge 74e of the second support wall 74 is attached to the outer surface 62e of the second support arm 62. The bottom edge 74d is free.

In an embodiment, the support arms 60, 62, the cross-brace 64 and mount plate 66 are formed of metal and are affixed to each other by welding. In an embodiment, the cross-brace 64 is eliminated and the mount plate 66 extends between the support arms 60, 62.

As shown in FIG. 1, the mounting member 56 is mounted to the elbow 42 of the cable puller 22 by attaching the support arms 60, 62 to the respective plates 44a, 44b. A roller 76 may be mounted between the support arms 60, 62 of the mount plate 66 for guiding the cable.

The clamping and engaging assembly 122, 222, 322, 422, 522 is attached to the mount plate 66. A first embodiment of the clamping and engaging assembly 122 is shown in FIGS. 1-16; a second embodiment of the clamping and engaging assembly 22 is shown in FIG. 17; a third embodiment of the clamping and engaging assembly 322 is shown in FIGS. 18-28; a fourth embodiment of the clamping and engaging assembly 422 is shown in FIGS. 29-40; and a fifth embodiment of the clamping and engaging assembly 422 is shown in FIGS. 41-49. Each embodiment of the clamping and engaging assembly 122, 222, 322, 422, 522 includes at least one clamp plate 124, 324, 424, 524 and at least one engaging member 126, 326, 426, 526. In an embodiment, the clamping and engaging assembly 122, 222, 322, 422, 522 includes at least two separate engaging members 126, 126′, 326, 326′, 426, 426′, 526, 526′. The clamping and engaging assembly 122, 222, 322, 422, 522 provides at least one surface 128, 228, 328, 428, 528 forming a ledge against which the end surface 32 of the conduit 24 bears against to hold the load on the conduit 24 during a pull. In an embodiment, the clamping and engaging assembly 122, 222, 322, 422, 522 provides at least two surfaces 128, 128′, 328, 328′, 428, 428′, 528, 528′ forming ledges against which the end surface 32 of the conduit 24 bears against to hold the load on the conduit 24 during a pull. It is desirable to maximize the contact area between the end surface 32 of the conduit 24 and the ledge surface 128, 228, 328, 428, 528 or ledge surfaces 128, 128′, 328, 328′, 428, 428′, 528, 528′; a greater contact area results in less pressure on the conduit 24 during a pulling operation. In an embodiment, the clamping and engaging assembly 422, 522 includes at least two separate clamp plates 424, 424′, 524, 524′.

Attention is invited to the first embodiment of the clamping and engaging assembly 122 shown in FIGS. 1-16. As shown, the clamping and engaging assembly 122 includes the adjustable position clamp plate 124 which is attached to the mount plate 66 by an adjustment knob 125, and first and second engaging members 126, 126′ affixed in position to the mount plate 66. In this embodiment, the base wall 70 of the mount plate 66 has an aperture 78 provided therethrough. In an embodiment, the aperture 78 is elongated. The clamp plate 124 is positioned between the engaging members 126, 126′.

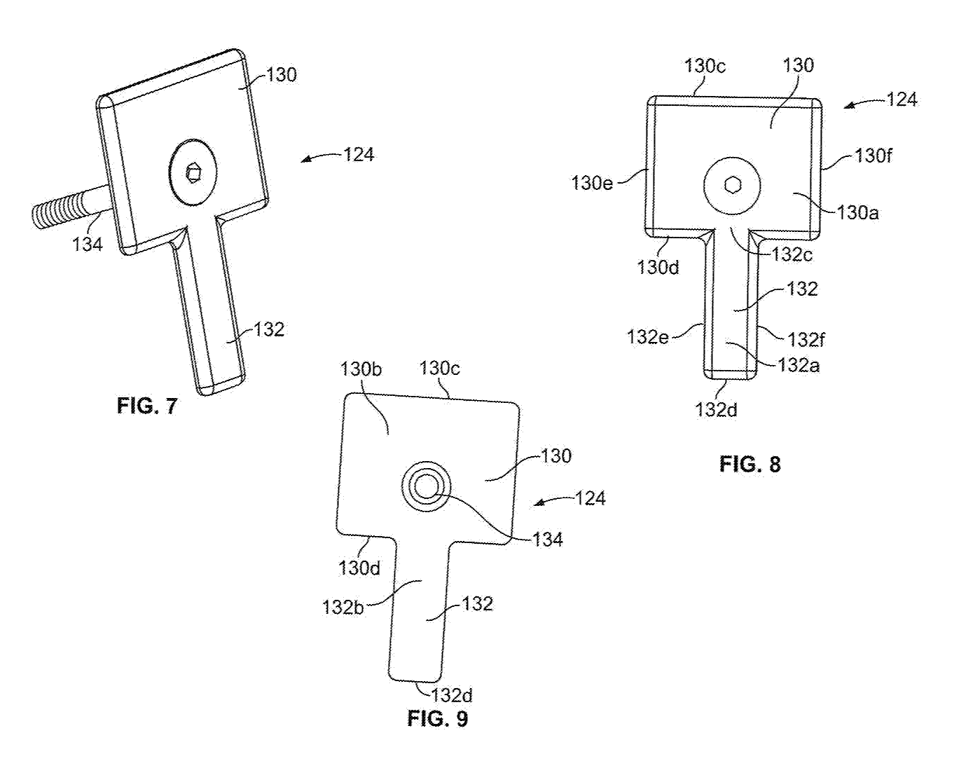

As shown in FIGS. 7-9, in an embodiment, the clamp plate 124 includes a first upper portion 130 and a second lower portion 132 which extends from the upper portion 130. The upper portion 130 has a front surface 130a and an opposite rear surface 130b which defines a top edge 130c, a bottom edge 130d and opposite side edges 130e, 130f The lower portion 132 has a front surface 132a and an opposite rear surface 132b which defines a top end 132c, a bottom edge 132d and opposite side edges 132e, 132f. The lower portion 132 extends from the bottom edge 132d of the upper portion 130. In an embodiment, the lower portion 132 extends from a central section of the bottom edge 132d. In an embodiment, the lower portion 132 is narrower than the upper portion 130. In an embodiment, the upper portion 130 and the lower portion 132 are generally planar and rectangularly-shaped. In an embodiment, the upper portion 130 and the lower portion 132 generally form a T-shape. In an embodiment, the upper and lower portions 130, 132 have the same width.

The clamp plate 124 further includes a threaded shaft 134 which extends from the rear surface 130b of the upper portion 130. In an embodiment, the threaded shaft 134 extends perpendicularly from the upper portion 130. In an embodiment, the threaded shaft 134 is integrally formed with the upper portion 130.

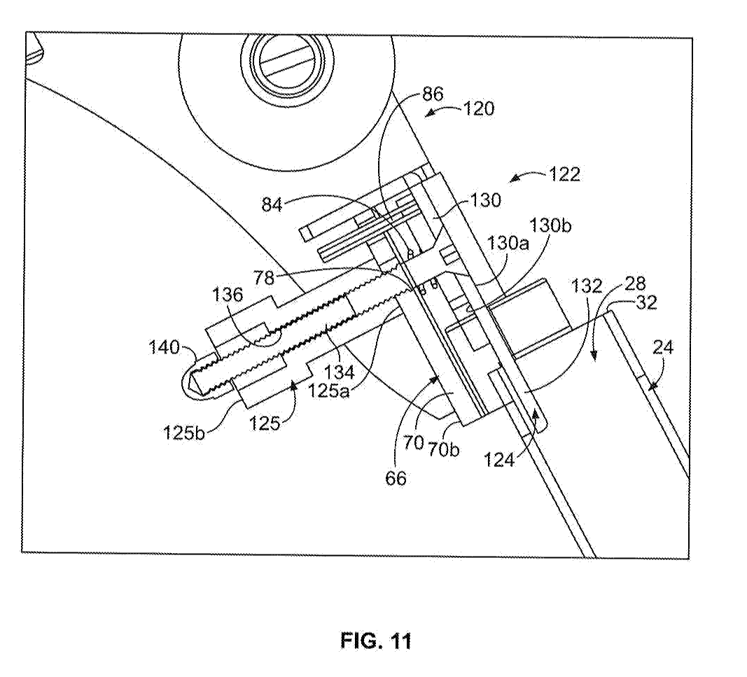

To connect the clamp plate 124 to the mounting member 56, the threaded shaft 134 extends through the aperture 78 in the base wall 70 of the mounting plate 66, see FIG. 11.

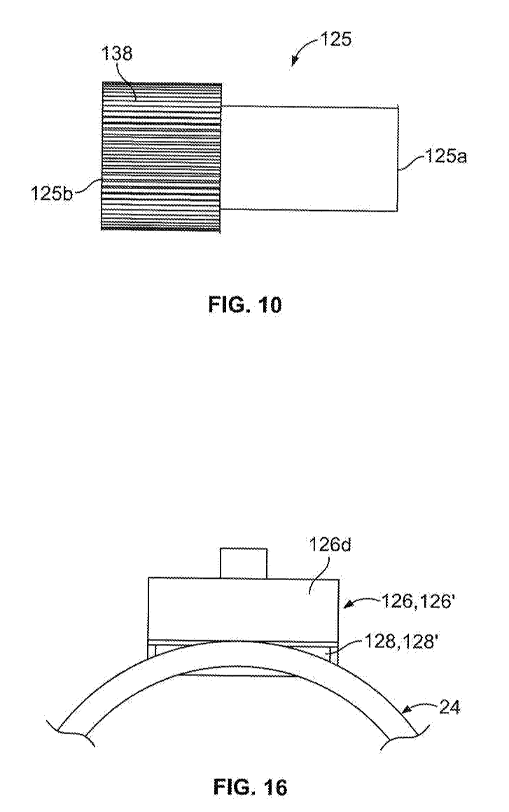

As shown in FIGS. 10 and 11, the knob 125 is formed of a body having a forward end 125a and a rearward end 125b through which a passageway 136 is provided. In an embodiment, the knob 125 has a gripping surface 138 which in an embodiment is formed on an enlarged portion of the body. The passageway 136 is at least partially threaded. The forward end 125a of the knob 125 engages the rear surface 70b of the mount plate 66.

As shown in FIG. 11, the threaded shaft 134 of the clamp plate 124 extends through the passageway 136 of the knob 125 and threadedly engages with the threads provided in the passageway 136. In an embodiment, a nut 140 is threaded onto the end of the threaded shaft 134 and may seat within an enlarged section of the passageway 136.

In an embodiment, the first engaging member 126 is provided proximate to the bottom edge 72d of the first support wall 72 of the mount plate 66. In an embodiment, the first engaging member 126 spans the width of the first support wall 72 defined between the side edges 72e, 72f. In an embodiment, the second engaging member 126′ is provided proximate the bottom edge 74d of the second support wall 74 of the mount plate 66. In an embodiment, the second engaging member 126′ spans the width of the second support wall 74 defined between the side edges 72e, 72f The mount plate 66 and the first and second engaging members 126, 126′ form a generally V-shaped groove. In an embodiment, the mount plate 66 and the first and second engaging members 126, 126′ are separately formed and the first and second engaging members 126, 126′ are attached to the mount plate 66, for example by welding or by fasteners. In an embodiment, the mount plate 66 and the first and second engaging members 126, 126′ are integrally formed.

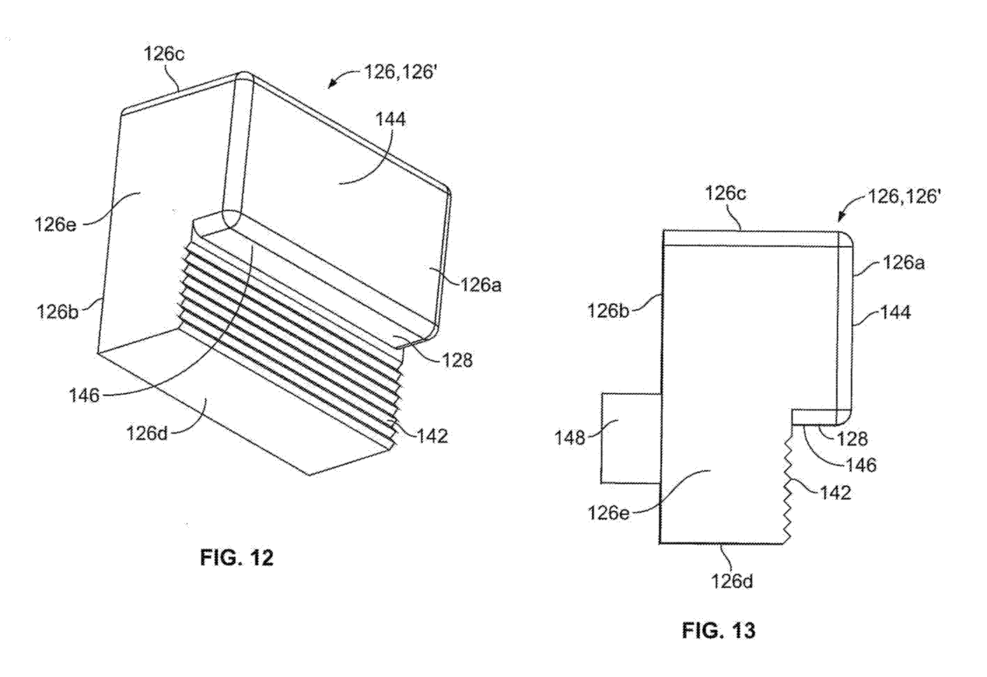

As shown in FIGS. 12-15, each engaging member 126, 126′ is generally formed as a block having a front surface 126a, a rear surface 126b, a top surface 126c extending between the front and rear surfaces 126a, 126b, a bottom surface 126c extending between the front and rear surfaces 126a, 126b, a first side surface 126d extending between the front and rear surfaces 126a, 126b and the top and bottom surfaces 126c, 126d, and a second side surface 126e extending between the front and rear surfaces 126a, 126b and the top and bottom surfaces 126c, 126d. The front surface 126a forms the ledge surface 128 which, in use, rests upon the end surface 32 of the conduit 24. In an embodiment, the ledge surface 128 is formed by a lower portion of the front surface 126a being offset from an upper portion of the front surface 126a. In this embodiment, the front surface 126a is formed of a lower wall portion 142, an upper wall portion 144 which is parallel to, but offset from the lower wall portion 142, and an intermediate wall portion 146 which is perpendicular to the lower and upper wall portions 142, 144. The intermediate wall portion 146 forms the ledge surface 128. Other structures forming the ledge surface 128 are within the scope of the present disclosure. For example, in an embodiment, the ledge surface 128 is formed of a protrusion (not shown) extending outwardly from the front surface 126a of the engaging member 126, 126′, the protrusion extending from the first side surface 126e of the engaging member 126, 126′ to the second side surface 126f of the engaging member 126, 126′. For example, in an embodiment, the ledge surface 128 is formed of a protrusion (not shown) extending outwardly from the front surface 126a of the engaging member 126, 126′, the protrusion extending partially between the first side surface 126e of the engaging member 126, 126′ and the second side surface 126f of the engaging member 126, 126′. In an embodiment, the engaging members 126, 126′ are affixed to the mount plate 66 by respective protrusions 148 which mate with respective apertures 80, 82 in the support walls 72, 74. In an embodiment, the engaging members 126, 126′ are affixed to the mount plate 66 by welding.

The attachment system 120 is attached to the conduit 24. To effect this, the clamp plate 124 is moved away from the mount plate 66 and the first and second engaging members 126, 126′ by rotating the knob 125 in a first direction which causes the threaded shaft 134 to translate relative to the knob 125 and move the clamp plate 124 away from the base wall 70 of the mount plate 66. The end of the conduit 24 is then placed between the clamp plate 124 and the first and second engaging members 126, 126′. The first and second engaging members 126, 126′ are positioned on the conduit 24 such that the end surface 32 of the conduit 24 is in contact with the ledge surfaces 128, 128′ of the first and second engaging members 126, 126′, the lower wall portions 142 of the first and second engaging members 126, 126′ are proximate to the thread 34 on the conduit 24, and the lower portion 132 of the clamp plate 124 extends into the passageway 28 of the conduit 24. The knob 125 is then rotated in a second direction opposite to the first direction, which causes the threaded shaft 134 to translate relative to the knob 125 in the opposite direction and draw the clamp plate 124 closer to the base wall 70, thereby gripping the conduit 24 between the lower portion 132 of the clamp plate 124 and the lower wall portions 142 of the first and second engaging members 126, 126′. In this gripping position, the end surface 32 of the conduit 24 contacts the ledge surfaces 128, 128′ of the first and second engaging members 126, 126′, the lower wall portions 142 of the first and second engaging members 126, 126′ engage the thread 34 on the conduit 24, and the rear surface 132b of the lower portion 132 of the clamp plate 124 engages the inner surface 26 of the conduit 24. The ledge surfaces 128, 128′ of the first and second engaging members 126, 126′ hold the load on the conduit 24 during a pull. It is desirable to maximize the contact area between the end surface 32 of the conduit 24 and the ledge surfaces 128, 128′; a greater contact area results in less pressure on the conduit 24. Thereafter, the pull by the cable puller 22 can be commenced.

In an embodiment, the threaded shaft 134 is a conventional fastener, shown in FIG. 11, formed of a threaded shaft having an enlarged head at an end thereof, and the clamping and engaging assembly 122 further includes a compressible member 84, see FIG. 11, provided between the clamp plate 124 and the mount plate 66. The fastener 164 extends through an aperture in the clamp plate 124 such that the head is retained within the aperture and the threaded shaft 134 extends from a rear surface of the upper portion of the clamp plate 124. The compressible member 84 seats between the clamp plate 124 and the base wall 70 of the mount plate 66. In an embodiment, the compressible member 84 seats between the upper portion 130 of the clamp plate 124 and the base wall 70 of the mount plate 66. In an embodiment, the compressible member 84 is a coil spring and the fastener extends through the center of the spring. In an embodiment, the compressible member 84 is a piece of rubber, and the fastener extends through a central passageway of the piece of rubber. Other compressible members are within the scope of the present disclosure. The compressible member 84 biases the clamp plate 124 into engagement with the head of the fastener.

In an embodiment, the clamping and engaging assembly 122 further includes an alignment pin 86, see FIG. 11, which extends from the rear surface 130b of the upper portion 130 of the clamp plate 124. In an embodiment, the alignment pin 86 is perpendicular to the upper portion 130. In an embodiment, the alignment pin 86 is cylindrical. In this embodiment, the base wall 70 has a further aperture 88 provided therethrough. In an embodiment, the aperture 88 is circular. In an embodiment, the aperture 88 is provided proximate to the top edge 70c of the base wall 70, and the aperture 78 is provided below the aperture 88. In an embodiment, the aperture 78 is provided proximate to the top edge 70c of the base wall 70, and the aperture 88 is provided below the aperture 78. The alignment pin 86 extends through the aperture 88 and assists in orienting the clamp plate 124 as the clamp plate 124 moves relative to the mount plate 66.

Attention is invited to the second embodiment of the attachment system 220 which includes the clamping and engaging assembly 222 shown in FIG. 17. The clamping and engaging assembly 222 is identical to the clamping and engaging assembly 122 of the first embodiment shown in FIGS. 1-16, except that a third engaging member 250 is provided. This embodiment is adapted for use with smaller diameter conduits 24. In this embodiment, the third engaging member 250 extends from the base wall 70. In an embodiment, the third engaging member 250 is formed identically to the first and second engaging members 126, 126′. The ledge surface 228 of the third engaging member 250 further holds the load on the conduit 24 during a pull. In an embodiment, the third engaging member 250 is only formed of a block. The bottom surface of the block forms the ledge surface 228 which, in use, rests upon the end surface 32 of the conduit 24.

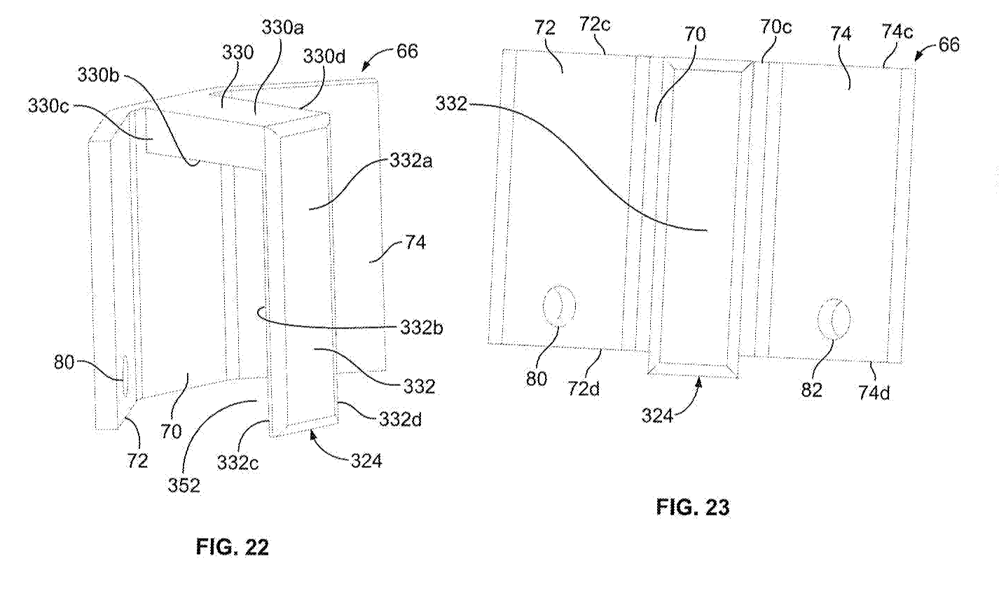

Attention is invited to the third embodiment of attachment system 320 which includes the clamping and engaging assembly 322 shown in FIGS. 18-28. The clamping and engaging assembly 322 includes a fixed position clamp plate 324 affixed to the mount plate 66 and adjustable position first and second engaging members 326, 326′, each attached to the mount plate 66 by an adjustment knob 325. In this embodiment as shown in FIGS. 22 and 23, each support wall 72, 74 of the mount plate 66 has the apertures 80, 82 provided therethrough, but the apertures 78, 88 are not provided. In an embodiment, the apertures 80, 82 are circular. In an embodiment, the apertures 80, 82 are square, elongated, etc. The clamp plate 324 is positioned between the engaging members 326, 326′.

As best shown in FIG. 22, the clamp plate 324 extends outwardly from the base wall 70 of the mount plate 66. The clamp plate 324 is formed of a first leg or portion 330 which extends outwardly from the base wall 70 of the mount plate 66 and a second leg or portion 332 which extends downwardly from the first portion 330. In an embodiment, the first portion 330 is proximate to the top edge 70c of the base wall 70. The first portion 330 is formed of an upper surface 330a, a lower surface 330b and side surfaces 330c, 330d extending between the upper and lower surfaces 330a, 330b. The second portion 332 is formed of a front surface 332a, a rear surface 332b and side surfaces 332c, 332d extending between the front and rear surfaces 332a, 332b. A space 352 is formed between the rear surface 332b of the second portion 332 and the front surface 70a of the base wall 70 of the mount plate 66. In an embodiment, the first portion 330 is perpendicular to the base wall 70 and the second portion 332 is perpendicular to the first portion 330.

In an embodiment, the first engaging member 326 is provided proximate to the bottom edge 72d of the first support wall 72 of the mount plate 66. In an embodiment, the first engaging member 326 spans the width of the first support wall 72 defined between the side edges 72e, 72f. In an embodiment, the second engaging member 326′ is provided proximate the bottom edge 74d of the second support wall 74 of the mount plate 66. In an embodiment, the second engaging member 326′ spans the width of the second support wall 74 defined between the side edges 72e, 72f The mount plate 66 and the first and second engaging members 326, 326′ form a generally V-shaped groove.

As shown in FIGS. 25-28, each engaging member 326, 326′ is generally formed as a block having a front surface 326a, a rear surface 326b, a top surface 326c extending between the front and rear surfaces 326a, 326b, a bottom surface 326c extending between the front and rear surfaces 326a, 326b, a first side surface 326d extending between the front and rear surfaces 326a, 326b and the top and bottom surfaces 326c, 326d, and a second side surface 326e extending between the front and rear surfaces 326a, 326b and the top and bottom surfaces 326c, 326d. The front surface 326a forms the ledge surface 328 which, in use, rests upon the end surface 32 of the conduit 24. In an embodiment, the ledge surface 328 is formed by a lower portion of the front surface 326a being offset from an upper portion of the front surface 326a. In this embodiment, the front surface 326a is formed of a lower wall portion 342, an upper wall portion 344 which is parallel to, but offset from the lower wall portion 342, and an intermediate wall portion 346 which is perpendicular to the lower and upper wall portions 342, 344. The intermediate wall portion 346 forms the ledge surface 328. Other structures forming the ledge surface 328 are within the scope of the present disclosure. For example, in an embodiment, the ledge surface 328 is formed of a protrusion (not shown) extending outwardly from the front surface 326a of the engaging member 326, 326′, the protrusion extending from the first side surface 326e of the engaging member 326, 326′ to the second side surface 326f of the engaging member 326, 326′. For example, in an embodiment, the ledge surface 328 is formed of a protrusion (not shown) extending outwardly from the front surface 326a of the engaging member 326, 326′, the protrusion extending partially between the first side surface 326e of the engaging member 326, 326′ and the second side surface 326f of the engaging member 326, 326′.

Each engaging member 326, 326′ further includes a threaded shaft 354 extending from its rear surface 326b. The threaded shaft 354 may be integrally formed with the respective engaging member 326, 326′, or may be separately formed and attached thereto by suitable means, such as welding or fasteners. In an embodiment, the threaded shaft 354 is a conventional fastener like that shown in FIG. 11, and further includes a compressible member, see FIG. 11, provided between the respective engaging member 326, 326′ and the mount plate 66.

To connect the engaging member 326, 326′ to the mounting member 56, the threaded shaft 354 of each engaging member 326, 326′ extends through the aperture 80, 82 in the respective support wall 72, 84.

As shown in FIG. 24, each knob 325 is formed of a body having a forward end 325a and a rearward end 325b through which a passageway 336 is provided. In an embodiment, each knob 325 has a gripping surface 338 which in an embodiment is formed on an enlarged portion of the body. The passageway 336 is at least partially threaded. The forward end 325a of the respective knob 325 engages the rear surfaces 72b, 74b of the mount plate 66.

The threaded shaft 354 of the engaging member 326, 326′ extends through the passageway 336 of the knob 325 and threadedly engages with the threads provided in the passageway 336. In an embodiment, a nut (not shown) is threaded onto the end of the threaded shaft 354 and may seat within an enlarged section of the passageway 336.

The attachment system 320 is attached to the conduit 24. To effect this, the engaging members 326, 326′ are moved toward the mount plate 66 by rotating the knobs 325 in a first direction which causes the respective threaded shaft 354 to translate relative to its knob 325 and move the engaging members 326, 326′ toward the support walls 72, 74 of the mount plate 66. The end of the conduit 24 is then placed between the second portion 332 of the clamp plate 324 and the first and second engaging members 326, 326′. The first and second engaging members 326, 326′ are positioned on the conduit 24 such that the end surface 32 of the conduit 24 is in contact with the ledge surfaces 328, 328′ of the first and second engaging members 326, 326′, the lower wall portions 342 of the first and second engaging members 326, 326′ are proximate to the thread 34 on the conduit 24, and the second portion 332 of the clamp plate 324 extends into the passageway 28 of the conduit 24. The knobs 325 are then rotated in a second direction opposite to the first direction, which causes the respective threaded shaft 354 to translate relative to its knob 325 in the opposite direction and move the engaging members 326, 326′ away from the support walls 72, 74, thereby gripping the conduit 24 between the second portion 332 of the clamp plate 324 and the lower wall portions 342 of the first and second engaging members 326, 326′. In this gripping position, the end surface 32 of the conduit 24 contacts the ledge surfaces 328, 328′ of the first and second engaging members 326, 326′, the lower wall portions 342 of the first and second engaging members 326, 326′ engage the thread 34 on the conduit 24, and the rear surface 332b of the second portion 332 of the clamp plate 324 engages the inner surface 26 of the conduit 24. The ledge surfaces 328, 328′ of the first and second engaging members 326, 326′ hold the load on the conduit 24 during a pull. It is desirable to maximize the contact area between the end surface 32 of the conduit 24 and the ledge surfaces 328, 328′; a greater contact area results in less pressure on the conduit 24. Thereafter, the pull by the cable puller 22 can be commenced.

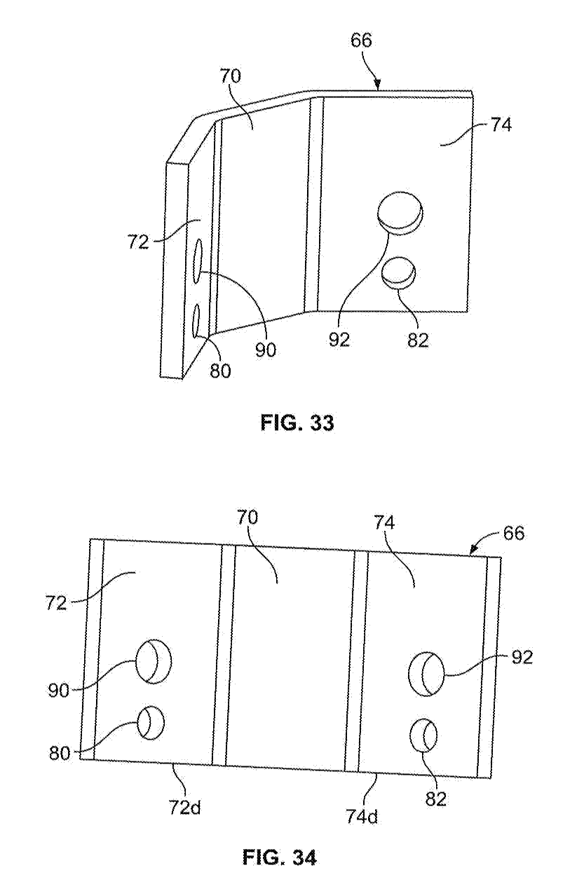

Attention is invited to the fourth embodiment of the attachment system 420 which includes the clamping and engaging assembly 422 shown in FIGS. 29-40. The clamping and engaging assembly 422 includes fixed position clamp plates 424, 424′ affixed to the mount plate 66 and adjustable position first and second engaging members 426, 426′, each attached to the mount plate 66 by an adjustment knob 425. In this embodiment as shown in FIGS. 33 and 34, each support wall 72, 74 of the mount plate 66 has the apertures 80, 82 provided therethrough, but the apertures 78, 88 are not provided. In an embodiment, the apertures 80, 82 are circular. In an embodiment, the apertures 80, 82 are square, elongated, etc. In an embodiment, the clamp plate 424 is positioned vertically above the engaging member 426, and the clamp plate 424′ is positioned vertically above the engaging member 426′.

The clamp plate 424 is affixed to and extends outwardly from the support wall 72; the clamp plate 424′ is affixed to extends outwardly from the support wall 74. As shown in FIGS. 31, 35 and 36, each clamp plate 424, 424′ is formed of a first leg or portion 430 which extends outwardly from the respective support wall 72, 74 of the mount plate 66 and a second portion 432 which extends downwardly from the first portion 430. In an embodiment, the first portion 430 of the clamp plate 424 extends outwardly from the midpoint of the support wall 72; the first portion 430 of the clamp plate 424′ extends outwardly from the midpoint of the support wall 74. Each first portion 430 is formed of an upper surface 430a, a lower surface 430b and side surfaces 430c, 430d extending between the upper and lower surfaces 430a, 430b. Each second portion 432 is formed of a front surface 432a, a rear surface 432b and side surfaces 432c, 432d extending between the front and rear surfaces 432a, 432b. In an embodiment, each first portion 430 is perpendicular to the respective support wall 72, 74 and each second portion 432 is perpendicular to the respective first portion 430. The lower surfaces 430b of the first portions 430 forms the ledge surfaces 428, 428′ which, in use, rests upon the end surface 32 of the conduit 24. In an embodiment, each first portion 430 is affixed to the mount plate 66 by a protrusion 456 which mates with an aperture 90, 92 in the respective support wall 72, 74. In an embodiment, the clamp plates 424, 424′ are affixed to the mount plate 66 by welding.

In an embodiment, the first engaging member 426 is provided proximate to the bottom edge 72d of the first support wall 72 of the mount plate 66. In an embodiment, the first engaging member 426 spans the width of the first support wall 72 defined between the side edges 72e, 72f. In an embodiment, the second engaging member 426′ is provided proximate the bottom edge 74d of the second support wall 74 of the mount plate 66. In an embodiment, the second engaging member 426′ spans the width of the second support wall 74 defined between the side edges 72e, 72f The mount plate 66 and the first and second engaging members 426, 426′ form a generally V-shaped groove.

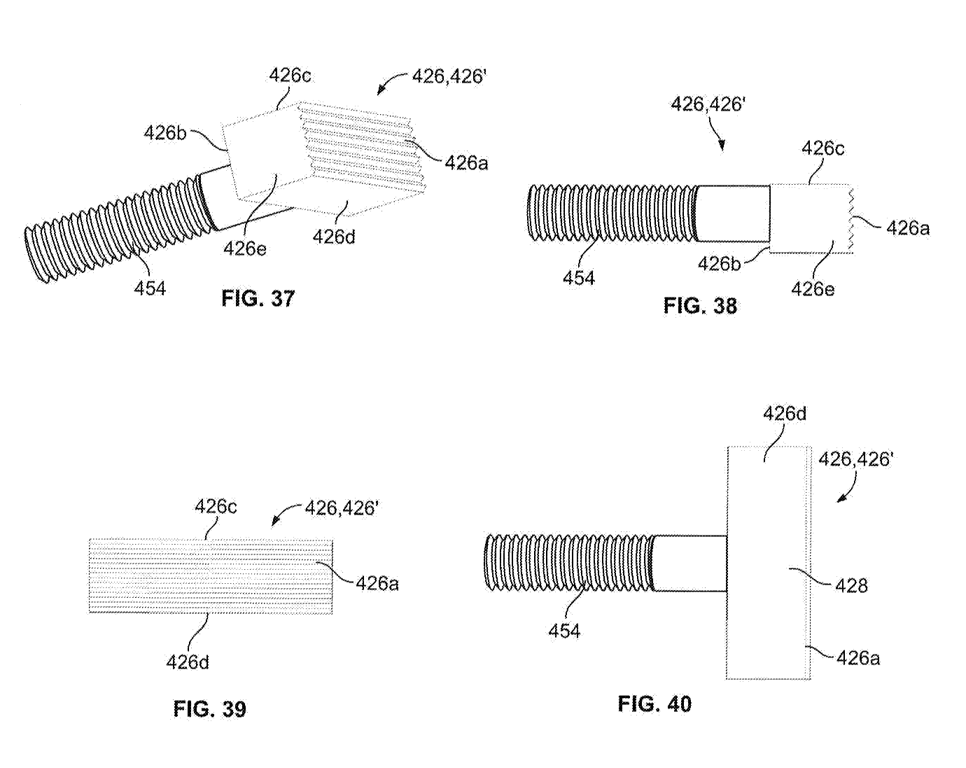

As shown in FIGS. 37-40, each engaging member 426, 426′ is generally formed as a block having a front surface 426a, a rear surface 426b, a top surface 426c extending between the front and rear surfaces 426a, 426b, a bottom surface 426c extending between the front and rear surfaces 426a, 426b, a first side surface 426d extending between the front and rear surfaces 426a, 426b and the top and bottom surfaces 426c, 426d, and a second side surface 426e extending between the front and rear surfaces 426a, 426b and the top and bottom surfaces 426c, 426d.

Each engaging member 426, 426′ further includes a threaded shaft 454 extending from its rear surface 426b. The threaded shaft 454 may be integrally formed with the respective engaging member 426, 426′, or may be separately formed and attached thereto by suitable means, such as welding or fasteners. In an embodiment, the threaded shaft 454 is a conventional fastener like that shown in FIG. 11, and further includes a compressible member, see FIG. 11, provided between the respective engaging member 426, 426′ and the mount plate 66.

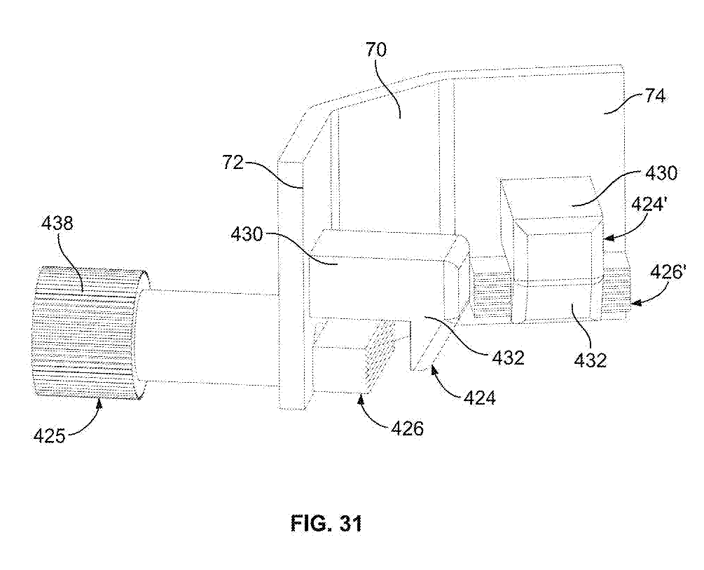

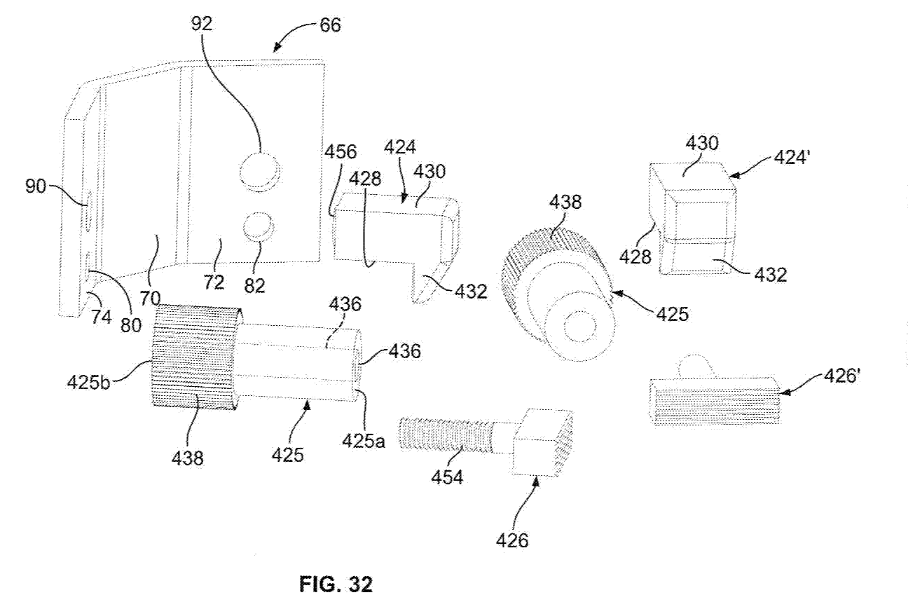

As shown in FIG. 32, each knob 425 is formed of a body having a forward end 425a and a rearward end 425b through which a passageway 436 is provided. In an embodiment, each knob 425 has a gripping surface 438 which in an embodiment is formed on an enlarged portion of the body. The passageway 436 is at least partially threaded. The forward end 425a of the respective knob 425 engages the rear surfaces 72b, 74b of the mount plate 66.

The threaded shaft 454 of the engaging member 426, 426′ extends through the passageway 436 of the knob 425 and threadedly engages with the threads provided in the passageway 436. In an embodiment, a nut (not shown) is threaded onto the end of the threaded shaft 454 and may seat within an enlarged section of the passageway 436.

The attachment system 420 is attached to the conduit 24. To effect this, the engaging members 426, 426′ are moved toward the mount plate 66 by rotating the knobs 425 in a first direction which causes the respective threaded shaft 454 to translate relative to its knob 425 and move the engaging members 426, 426′ toward the support walls 72, 74 of the mount plate 66. The end of the conduit 24 is then placed between the second portions 432 of the clamp plates 424, 424′ and the first and second engaging members 426, 426′. The end surface 32 of the conduit 24 is in contact with the ledge surfaces 428, 428′ of the clamp plates 424, 424′, the front surfaces 426a of the first and second engaging members 426, 426′ are proximate to the thread 44 on the conduit 24, and the second portions 432 of the clamp plates 424 extend into the passageway 28 of the conduit 24. The knobs 425 are then rotated in a second direction opposite to the first direction, which causes the respective threaded shaft 454 to translate relative to its knob 425 in the opposite direction and move the engaging members 426, 426′ away from the support walls 72, 74, thereby gripping the conduit 24 between the second portion 432 of the clamp plate 424 and the lower wall portions 442 of the first and second engaging members 426, 426′. In this gripping position, the end surface 32 of the conduit 24 contacts the ledge surfaces 428, 428′ of the clamp plates 424, 424′, the front surfaces 426a of the first and second engaging members 426, 426′ engage the thread 44 on the conduit 24, and the rear surfaces 432b of the second portions 432 of the clamp plates 424 engage the inner surface 26 of the conduit 24. The ledge surfaces 428, 428′ of the clamp plates 424, 424′ hold the load on the conduit 24 during a pull. It is desirable to maximize the contact area between the end surface 32 of the conduit 24 and the ledge surfaces 428, 428′; a greater contact area results in less pressure on the conduit 24. Thereafter, the pull by the cable puller 22 can be commenced.

Attention is invited to the fifth embodiment of the attachment system 520 which includes the clamping and engaging assembly 522 shown in FIGS. 41-49. The clamping and engaging assembly 522 includes first and second adjustable position clamp plates 524, 524′, each attached to the mount plate 66 by an adjustment knob 525, and fixed position first and second engaging members 526, 526′ affixed to the mount plate 66. In this embodiment as shown in FIG, 44, each support wall 72, 74 of the mount plate 66 has the apertures 80, 82 provided therethrough, but the apertures 78, 88 are not provided. In an embodiment, the apertures 80, 82 are circular. In an embodiment, the apertures 80, 82 are square, elongated, etc. In an embodiment, the clamp plate 524 is positioned vertically above the engaging member 526, and the clamp plate 524′ is positioned vertically above the engaging member 526′.

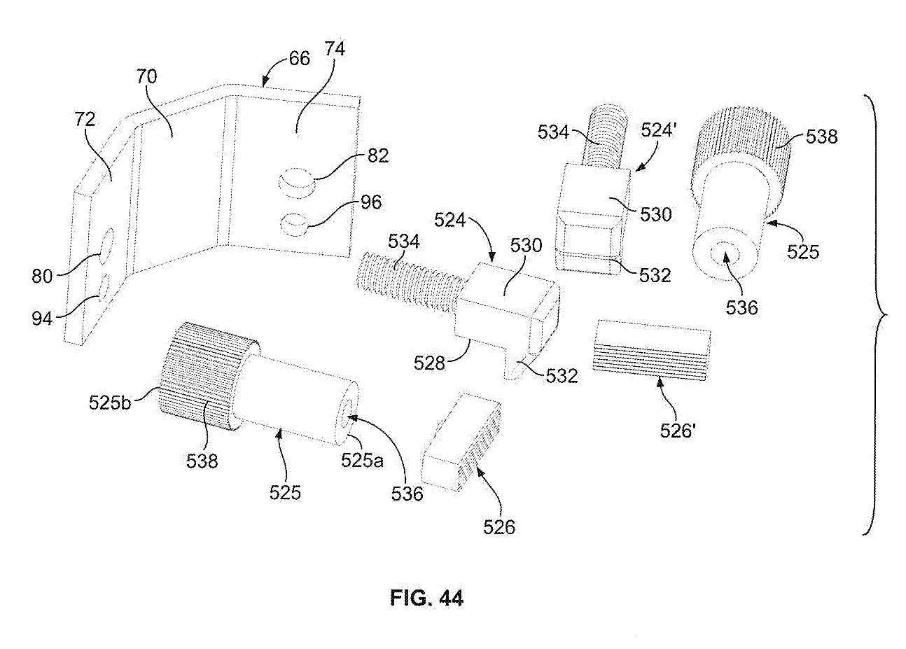

As best shown in FIGS. 44-46, the clamp plate 524 is proximate to and extends outwardly from the support wall 72 of the mount plate 66 and the clamp plate 524′ is proximate to and extends outwardly from the support wall 72 of the mount plate 66. Each clamp plate 524, 524′ is formed of a first leg or portion 530 which extends outwardly from the respective support wall 72, 74 of the mount plate 66 and a second portion 532 which extends downwardly from the first portion 530. In an embodiment, the first portion 530 of the clamp plate 524 extends outwardly from the midpoint of the support wall 72; the first portion 530 of the clamp plate 524′ extends outwardly from the midpoint of the support wall 74. Each first portion 530 is formed of an upper surface 530a, a lower surface 530b and side surfaces 530c, 530d extending between the upper and lower surfaces 530a, 530b. Each second portion 532 is formed of a front surface 532a, a rear surface 532b and side surfaces 532c, 532d extending between the front and rear surfaces 532a, 532b. In an embodiment, each first portion 530 is perpendicular to the respective support wall 72, 74 and each second portion 532 is perpendicular to the respective first portion 530. The lower surfaces 530b of the first portions 530 forms the ledge surfaces 528, 528′ which, in use, rests upon the end surface 32 of the conduit 24.

Each clamp plate 524, 524′ further includes a threaded shaft 534 extending from its rear surface 526b. The threaded shaft 534 may be integrally formed with the respective clamp plate 524, 524′, or may be separately formed and attached thereto by suitable means, such as welding or fasteners. In an embodiment, the threaded shaft 534 is a conventional fastener like that shown in FIG. 11, and further includes a compressible member, see FIG. 11, provided between the respective clamp plate 524, 524′ and the mount plate 66.

As shown in FIG. 44, each knob 525 is formed of a body having a forward end 525a and a rearward end 525b through which a passageway 536 is provided. In an embodiment, each knob 525 has a gripping surface 538 which in an embodiment is formed on an enlarged portion of the body. The passageway 536 is at least partially threaded. The forward end 525a of the respective knob 525 engages the rear surfaces 72b, 74b of the mount plate 66.

The threaded shaft 534 of each clamp plate 524, 524′ extends through the passageway 536 of the knob 525 and threadedly engages with the threads provided in the passageway 536. In an embodiment, a nut (not shown) is threaded onto the end of the threaded shaft 534 and may seat within an enlarged section of the passageway 536.

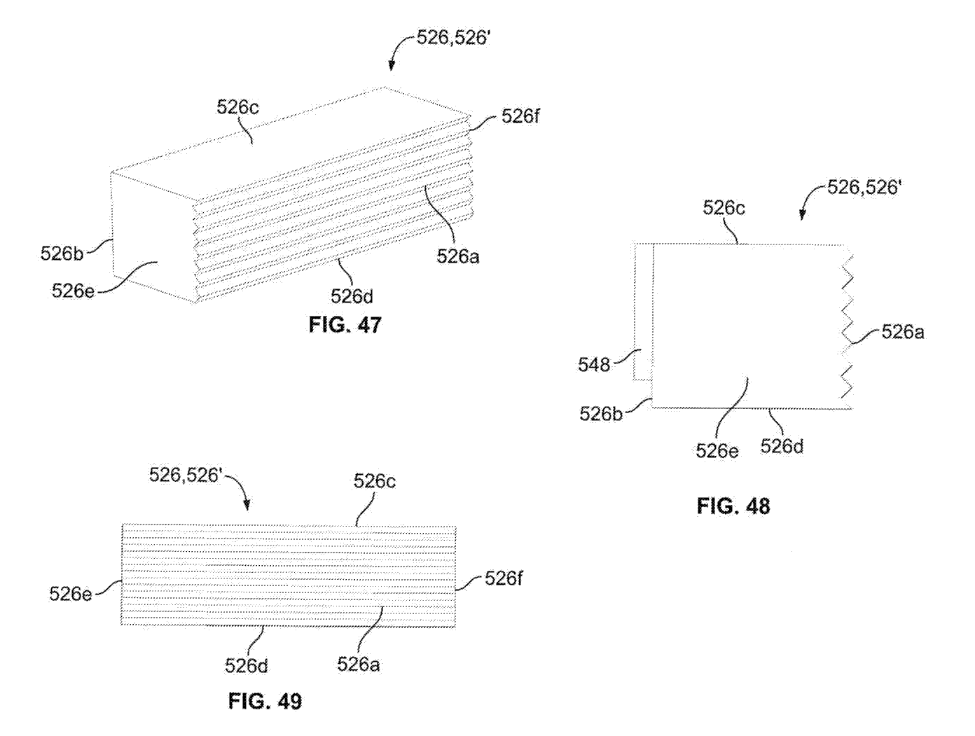

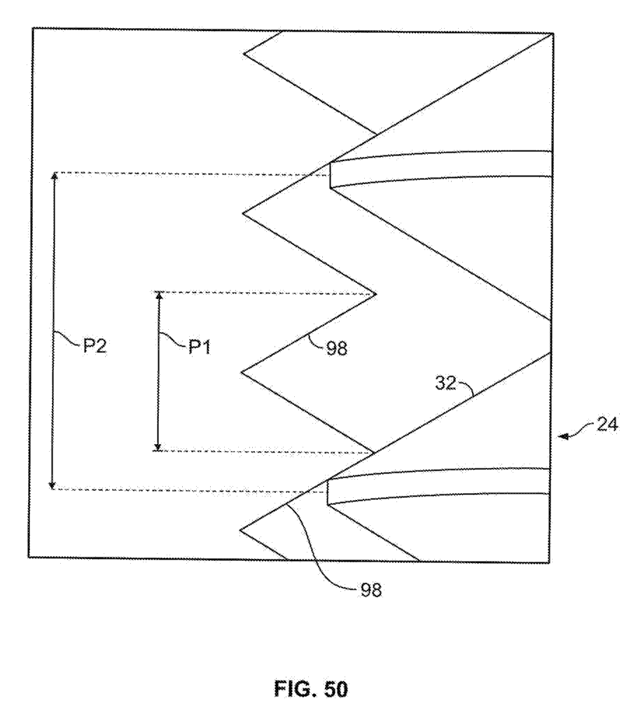

As shown in FIGS. 47-49, each engaging member 526, 526′ is generally formed as a block having a front surface 526a, a rear surface 526b, a top surface 526c extending between the front and rear surfaces 526a, 526b, a bottom surface 526c extending between the front and rear surfaces 526a, 526b, a first side surface 526d extending between the front and rear surfaces 526a, 526b and the top and bottom surfaces 526c, 526d, and a second side surface 526e extending between the front and rear surfaces 526a, 526b and the top and bottom surfaces 526c, 526d.

In an embodiment, the engaging members 526, 526′ are affixed to the mount plate 66 by respective protrusions 548 which mates with respective apertures 94, 96 in the support walls 72, 74. In an embodiment, the engaging members 526, 526′ are affixed to the mount plate 66 by welding. It will be appreciated that the engaging members 526, 526′ are shown in the drawings as a block of a rectangular prism that the engaging members 526, 526′ may take a variety of shapes.

In an embodiment, the first engaging member 526 is provided proximate to the bottom edge 72d of the first support wall 72 of the mount plate 66. In an embodiment, the first engaging member 526 spans the width of the first support wall 72 defined between the side edges 72e, 72f. In an embodiment, the second engaging member 526′ is provided proximate the bottom edge 74d of the second support wall 74 of the mount plate 66. In an embodiment, the second engaging member 526′ spans the width of the second support wall 74 defined between the side edges 72e, 72f The mount plate 66 and the first and second engaging members 526, 526′ form a generally V-shaped groove.

The attachment system 520 is attached to the conduit 24. To effect this, the clamp plates 524, 524′ are moved away from the mount plate 66 by rotating the knobs 525 in a first direction which causes the respective threaded shaft 534 to translate relative to its knob 525 and move the clamp plates 524, 524′ away from the support walls 72, 74 of the mount plate 66. The end of the conduit 24 is then placed between the second portions 532 of the clamp plates 524, 524′ and the first and second engaging members 526, 526′. The end surface 32 of the conduit 24 is in contact with the ledge surfaces 528, 528′ of the clamp plates 524, 524′, the front surfaces 526a of the first and second engaging members 526, 526′ are proximate to the thread 54 on the conduit 24, and the second portions 532 of the clamp plates 524 extend into the passageway 28 of the conduit 24. The knobs 525 are then rotated in a second direction opposite to the first direction, which causes the respective threaded shaft 534 to translate relative to its knob 525 in the opposite direction and move the clamp plates 524, 524′ toward the support walls 72, 74, thereby gripping the conduit 24 between the second portions 532 of the clamp plates 524, 524′ and the front surfaces 526a of the first and second engaging members 526, 526′. In this gripping position, the end surface 32 of the conduit 24 contacts the ledge surfaces 528, 528′ of the clamp plates 524, 524′, the front surfaces 526a of the first and second engaging members 526, 526′ engage the thread 54 on the conduit 24, and the rear surfaces 532b of the second portions 532 of the clamp plates 524, 524′ engage the inner surface 26 of the conduit 24. The ledge surfaces 528, 528′ of the clamp plates 524, 524′ hold the load on the conduit 24 during a pull. It is desirable to maximize the contact area between the end surface 32 of the conduit 24 and the ledge surfaces 528, 528′; a greater contact area results in less pressure on the conduit 24. Thereafter, the pull by the cable puller 22 can be commenced.

While a threaded screw connection is shown and described to adjust the position of the adjustable position clamp plate 124, the adjustable position engaging members 326, 326′, the adjustable position engaging members 426, 426′, and the adjustable position clamp plates 524, 524′, it is to be understood that other structures for adjusting the position, while still enabling the plates/members to be moved to the gripping position, are within the scope of the present disclosure. For example, the clamp plate 124, the engaging members 326, 326′, the engaging members 426, 426′, and the clamp plates 524, 524′could be adjusted in position by using a fulcrum.

In an embodiment, the front surface 126a, 326a, 426a, 526a of each engaging member 126, 126′, 326, 326′, 426, 426′, 526, 526′ that engages the threads 34 of the conduit 24 in the gripping position is smooth.

In an embodiment, a plurality of teeth 98 is provided on the front surface 126a, 326a, 426a, 526a of each engaging member 126, 126′, 326, 326′, 426, 426′, 526, 526′ that engages the threads 34 of the conduit 24 in the gripping position. In an embodiment, the teeth 98 are formed by grooves or texturing. In an embodiment, the teeth 98 are formed by serrations or a thread form which define a pitch P1 between adjacent crests. The threads 34 on the conduit 24 define a pitch P2 between adjacent crests in the thread form. The pitch P1 is substantially less than the pitch P2. In an embodiment, the pitch P1 is half or about half of the pitch P2. As such, the teeth 98 on the engaging members 126, 126′, 326, 326′, 426, 426′, 526, 526′ has a finer pitch than the pitch on the conduit 24. As a result, the engaging members 126, 126′, 326, 326′, 426, 426′, 526, 526′ provides for a “slight engagement” that enables the attachment system 120, 220, 320, 420, 520 to be easy to use, and robust enough to withstand a 6000 lbs. cable pull in various embodiments. During setup of the cable puller 22, the teeth 98 of the engaging members 126, 126′, 326, 326′, 426, 426′, 526, 526′ partially engage with the thread 34 on the conduit 24, but do not fully engage. In this position, the teeth 98 of the engaging members 126, 126′, 326, 326′, 426, 426′, 526, 526′ are loaded and support the weight of the cable puller 22 during set-up. When the pull begins, if the ledge surfaces 128, 228, 328, 428, 528 are not fully in contact with the end surface 32 of the conduit 24, the force of the pull will load the teeth 98 of the engaging members 126, 126′, 326, 326′, 426, 426′, 526, 526′ until the teeth 98 slip from the threads 34 of the conduit 24, and the ledge surfaces 128, 228, 328, 428, 528 come into contact with the end surface 32 of the conduit 24. The engaging members 126, 126′, 326, 326′, 426, 426′, 526, 526′ can slip across the threads 34 of the conduit 24 without impeding the function of the threads 34. Once the engaging members 126, 126′, 326, 326′, 426, 426′, 526, 526′ have slipped into place, the ledge surfaces 128, 228, 328, 428, 528 carry the load of the cable pull until it is completed. In an embodiment, the teeth 98 on the engaging members 126, 126′, 326, 326′, 426, 426′, 526, 526′ are milled. It is to be understood that the size, the depth angle, the density, the orientation of the teeth 98 can be varied, provided that the dimensions of the teeth 98 increases the surface area which grips the threads 34 of the conduit 24 during the initial set up, without fully engaging the threads 34 of the conduit 24.

It is to be understood that the clamp plate 524 and knob 525 shown in the fifth embodiment of FIGS. 41-49 may be used as the clamp assembly of the first embodiment shown in FIGS. 1-16.

It is to be understood that the third engaging member 250 of FIG. 17 may be used in any of the embodiments.

While some of the embodiments herein show one of the engaging members and the clamp plate or clamp plates being fixed into position relative to the mounting member 56 and the other of the engaging members and the clamp plate or clamp plates being adjustable in position relative to the mounting member 56, both of the engaging member and the clamp plate or clamp plates can be adjustable in position relative to the mounting member 56.

The clamping and engaging assembly 122 of various embodiments accommodates at least 6000 lbs. of pull force. The clamping and engaging assembly 122 is adjustable to fit a range of conduit sizes.

While two or three engaging members are shown and described, the number of engaging members, the sizes of the engaging members, the angle between the engaging members, etc. can be varied to increase gripping contact area with the conduit 24, as well as ledge surface 128, 228, 328, 428, 528 or ledge surfaces 128, 128′, 328, 328′, 428, 428′, 528, 528′ contact area with the conduit 24.

In addition to providing attachment between the cable puller 22 and the conduit 24, the attachment system 120, 220, 320, 420, 520 provides a mechanism for transferring forces from the puller 22 to the conduit 24 as the cable is pulled through the conduit 24. As cable is pulled through the conduit 24, forces from the puller 22 are transferred from the puller 22, to the clamp plate 124 and to the conduit 24 by way of the ledge surface 128, 228, 328, 428, 528 or ledge surfaces 128, 128′, 328, 328′, 428, 428′, 528, 528′.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. An attachment system configured to be attached to a cable puller for securing the cable puller to a threaded conduit having a passageway, the attachment system comprising:
a mounting member configured to be attached to the cable puller;
an engaging member attached to the mounting member;
a clamp plate attached to the mounting member, the clamp plate configured to be inserted into the passageway of the conduit and configured to bear against the conduit;
one of the engaging member and the clamp plate having a ledge surface upon which the conduit bears against; and
at least one of the engaging member and the clamp plate is adjustable in position relative to the mounting member.

2. The attachment system of claim 1, wherein one of the engaging member and the clamp plate is fixed into position relative to the mounting member and the other of the engaging member and the clamp plate is adjustable in position relative to the mounting member.

3. The attachment system of claim 1, wherein the engaging member is fixed into position relative to the mounting member and the clamp plate is adjustable in position relative to the mounting member by a threaded connection between the clamp plate and the mounting member.

4. The attachment system of claim 1, wherein the clamp plate is fixed into position relative to the mounting member and the engaging member is adjustable in position relative to the mounting member by a threaded connection between the engaging member and the mounting member.

5. The attachment system of claim 1, wherein at least two engaging members are provided.

6. The attachment system of claim 5, wherein two clamp plates are provided.

7. The attachment system of claim 1, wherein the engaging member includes a plurality of teeth.

8. An attachment system configured to be attached to a cable puller for securing the cable puller to a threaded conduit having a passageway, the attachment system comprising:
a mounting member configured to be attached to the cable puller;
an engaging member attached to the mounting member, the engaging member having a first surface forming a ledge, wherein the first surface is configured to bear against an end surface of the conduit, and further having a second surface extending from the first surface, the second surface being offset from the first surface, the second surface configured to bear against an outer surface of the conduit;
a clamp plate attached to the mounting member, the clamp plate configured to be inserted into the passageway of the conduit and configured to bear against an inner surface of the conduit which forms the passageway;
wherein in use the conduit is configured to be clamped between the engaging member and the clamp plate; and
wherein at least one of the engaging member and the clamp plate is adjustable in position relative to the mounting member.

9. The attachment system of claim 8, wherein one of the engaging member and the clamp plate is fixed into position relative to the mounting member and the other of the engaging member and the clamp plate is adjustable in position relative to the mounting member.

10. The attachment system of claim 8, wherein the engaging member is fixed into position relative to the mounting member and the clamp plate is adjustable in position relative to the mounting member by a threaded connection between the clamp plate and the mounting member.

11. The attachment system of claim 8, wherein the clamp plate is fixed into position relative to the mounting member and the engaging member is adjustable in position relative to the mounting member by a threaded connection between the engaging member and the mounting member.

12. The attachment system of claim 8, wherein at least two engaging members are provided.

13. The attachment system of claim 12, wherein two clamp plates are provided.

14. The attachment system of claim 8, wherein the clamp plate includes a first portion and a second portion extending from the first portion, the first portion is wider than the second portion.

15. The attachment system of claim 8, wherein the clamp plate includes a first portion extending from the mounting member and a second portion extending from the first portion, the first and second portions being generally perpendicular to each other.

16. The attachment system of claim 8, wherein the engaging member includes a plurality of teeth.

17. An attachment system configured to be attached to a cable puller for securing the cable puller to a threaded conduit having a passageway, the attachment system comprising:
a mounting member configured to be attached to the cable puller;
an engaging member attached to the mounting member, the engaging member having a surface configured to bear against an outer surface of the conduit;
a clamp plate attached to the mounting member, the clamp plate having a first surface forming a ledge, wherein the first surface is configured to bear against an end surface of the conduit, and further having a second surface extending from the first surface, the second surface being offset from the first surface, the second surface configured to bear against an inner surface of the conduit which forms the passageway;
wherein in use the conduit is configured to be clamped between the engaging member and the clamp plate; and
wherein at least one of the engaging member and the clamp plate is adjustable in position relative to the mounting member.

18. The attachment system of claim 17, wherein one of the engaging member and the clamp plate is fixed into position relative to the mounting member and the other of the engaging member and the clamp plate is adjustable in position relative to the mounting member.

19. The attachment system of claim 17, wherein the engaging member is fixed into position relative to the mounting member and the clamp plate is adjustable in position relative to the mounting member by a threaded connection between the clamp plate and the mounting member.

20. The attachment system of claim 17, wherein the clamp plate is fixed into position relative to the mounting member and the engaging member is adjustable in position relative to the mounting member by a threaded connection between the engaging member and the mounting member.

21. The attachment system of claim 17, wherein at least two engaging members are provided.

22. The attachment system of claim 21, wherein two clamp plates are provided.

23. The attachment system of claim 17, wherein the engaging member includes a plurality of teeth.
